(19) United States
(12) Patent Application Publication
(10) Pub. No.: US 2017/0210106 A1
(43) Pub. Date: Jul. 27, 2017

(54) PACKAGING STRUCTURE

(71) Applicant: KYOCERA Document Solutions Inc., Osaka (JP)

(72) Inventor: Kazuyoshi YAMAMURA, Osaka-shi (JP)

(73) Assignee: KYOCERA Document Solutions Inc., Osaka (JP)

(21) Appl. No.: 15/404,273

(22) Filed: Jan. 12, 2017

(30) Foreign Application Priority Data
Jan. 26, 2016 (JP) 2016-012042

(51) Int. Cl. B32B 29/08; B65D 81/107; B32B 29/00

(52) U.S. Cl. CPC B32B 29/08; B32B 29/005; B65D 81/107; B32B 2553/00

(57) ABSTRACT

A packaging structure includes a plurality of laminated blocks produced by laminating a plurality of corrugated cardboards and then bonding them together. The laminated blocks are stacked in a vertical direction and interposed between a lower face of a packaged article and a bottom face of a packaging box.

### INCORPORATION BY REFERENCE

This application is based on and claims the benefit of priority from Japanese Patent application No. 2016-012042 filed on Jan. 26, 2016, the entire contents of which are incorporated herein by reference.

### BACKGROUND

The present disclosure relates to a packaging structure interposed between a packaged article and a packaging box.

An image forming apparatus, such as a printer and a copying machine, is sometimes provided with a sheet feeding unit, as an optional device, so as to be attachable thereto. The sheet feeding unit has screw-type casters mounted on its lower face so that a height of the sheet feeding unit can be adjusted according to a height of the image forming apparatus.

When a packaged article having projections on its lower face, such as the sheet feeding unit having the screw-type casters, is packaged into a packaging box, in order to protect the projections, such as the screw-type casters, a buffering member is interposed between the lower face of the packaged article and a bottom plate of the packaging box. In many cases, the buffering member is made of pulp molded product or foamed resin. However, in a case where a production volume of the packaged article is small or in a case where the packaged article has a heavy weight, the buffering member may be made of a laminated block which is produced by laminating a plurality of corrugated cardboards and bonding them together. Since the laminated block can be produced without using a dye, a producing cost can be reduced. In addition, the laminated block has sufficient pressure resistance strength.

By the way, the sheet feeding unit having the screw-type casters may be sometimes shipped with a height of the screw-type casters adjusted at a maximum height. The maximum height is about 130 mm, for example. In such a case, it is necessary to heighten the height of the buffering member to about 130 mm.

When the buffering member is made to be higher, since a number of the corrugated cardboards to be laminated increases, the corrugated cardboards maybe peeled off or inclined. Thus, a production yield of the laminated block may deteriorate. In addition, when the packaging box is fallen, sufficient strength against an impact may not be obtained. In a case where the laminated block is produced by laminating the plurality of corrugated cardboards in the vertical direction, when the packaging box is fallen with a ridge corner downward, the corrugated cardboards may be displaced each other at a bonded face between the corrugated cardboards. In a case where the laminated block is produced by laminating the plurality of corrugated cardboards in the horizontal direction, when the packaging box is fallen with the ridge corner downward, the buffering member may be deformed so as to be inclined. Particularly, in a case where a contact area between the packaged article and the buffering member is small, like as the sheet feeding unit having the screw-type casters, the above deformation occurs more easily.

### SUMMARY

In accordance with an embodiment of the present disclosure, a packaging structure includes a plurality of laminated blocks produced by laminating a plurality of corrugated cardboards and then bonding them together. The laminated blocks are stacked in a vertical direction and interposed between a lower face of a packaged article and a bottom face of a packaging box.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing a packaging box in which a packaged article is packaged via a packaging structure according to an embodiment of the present disclosure.

FIG. 2 is a perspective view showing the packaged article, viewed from a lower side, which is packaged via the packaging structure according to one embodiment of the present disclosure.

FIG. 3 is a perspective view showing the packaging structure according to the embodiment of the present disclosure.

FIG. 4 is an exploded perspective view showing the packaging structure according to the embodiment of the present disclosure.

FIG. 5A is a side view showing the packaging structure at packaging, according to the embodiment of the present disclosure.

FIG. 5B is a side view showing the packaging structure at falling, according to the embodiment of the present disclosure.

### DETAILED DESCRIPTION

Hereinafter, with reference to figures, a packaging structure according to an embodiment of the present disclosure will be described.

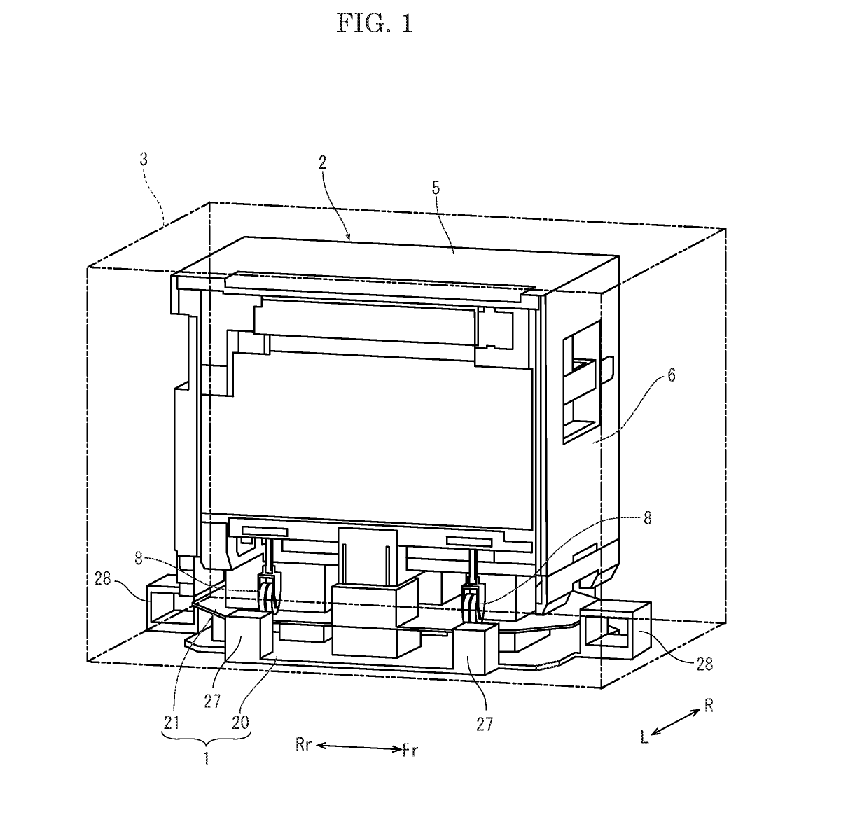

As shown in FIG. 1, a packaging structure 1 according to one embodiment of the present disclosure is interposed between a lower face of a sheet feeding unit 2 as a packaged article and a bottom face of a packaging box 3. The sheet feeding unit 2 is an optional device which is attached on a side face of an image forming apparatus and feeds a sheet to the image forming apparatus. In the following description, front and rear directions show front and rear directions shown in FIG. 1 and left and right directions are based on a direction in which the sheet feeding unit is shown from the front side. Fr, Rr, L and R in each figure respectively shows the front side, the rear side, the left side and the right side.

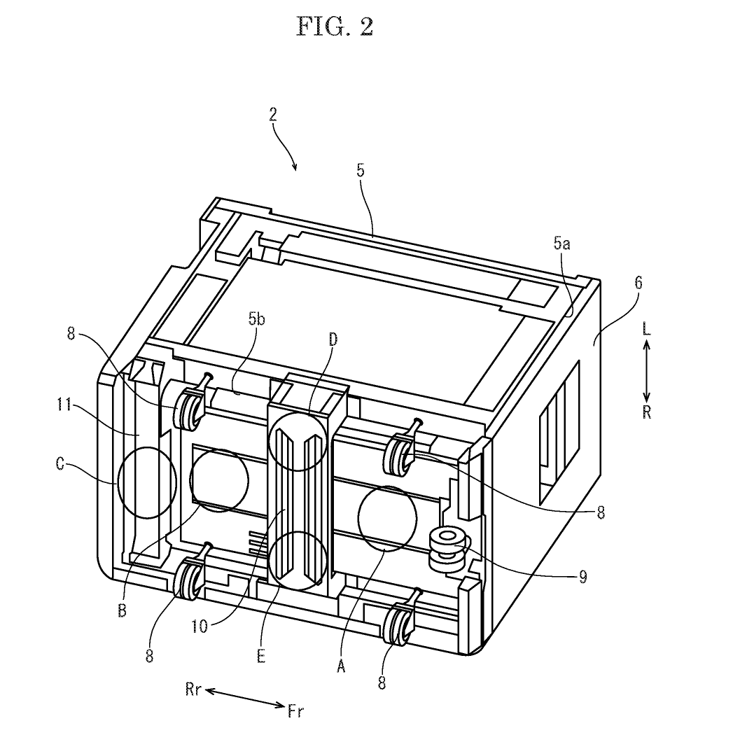

First, refer to FIG. 2, the sheet feeding unit 2 will be described. FIG. 2 is a perspective view showing the sheet feeding unit from the lower side. The sheet feeding unit 2 includes a rectangular parallelepiped box-shaped casing 5 and a tray 6 which is stored in the casing 5. In the tray 6, a plurality of sheets are stacked. The casing 5 is formed with openings 5a, 5b at the front face and the center portion of the bottom face respectively. The tray 6 is supported on the bottom face of the casing 5 and can be pulled out forward through the opening 5a.

At each corner of the lower face of the casing 5, a screw-type caster 8 is attached. By varying a screwing depth of the screw-type caster 8, a height of the sheet feeding unit 2 can be adjusted according to a height of the image forming apparatus. At the front end portion of the lower face of the casing 5, a tray caster 9 is attached.

In addition, on the lower face of the casing 5, a center frame 10 and an end frame 11 are bridged between lower edges of left and right side plates of the casing 5 in a space between the adjacent casters 8 in the front and rear directions and a space on the rear side of the rear side casters 8 respectively. A protruded length of the center frame 10 from the lower face of the casing 5 is equal to a protruded length of the end frame 11 from the lower face of the casing 5. A protruded length of the casters 8 and the tray caster 9 from the lower face of the casing 5 is longer than the protruded length of the center frame 10 and the end frame 11.

As shown in FIG. 1, the packaging box 3 has a rectangular bottom plate, side plates stood vertically along four edges of the bottom plate and lid flaps connected along upper edges of the side plates.

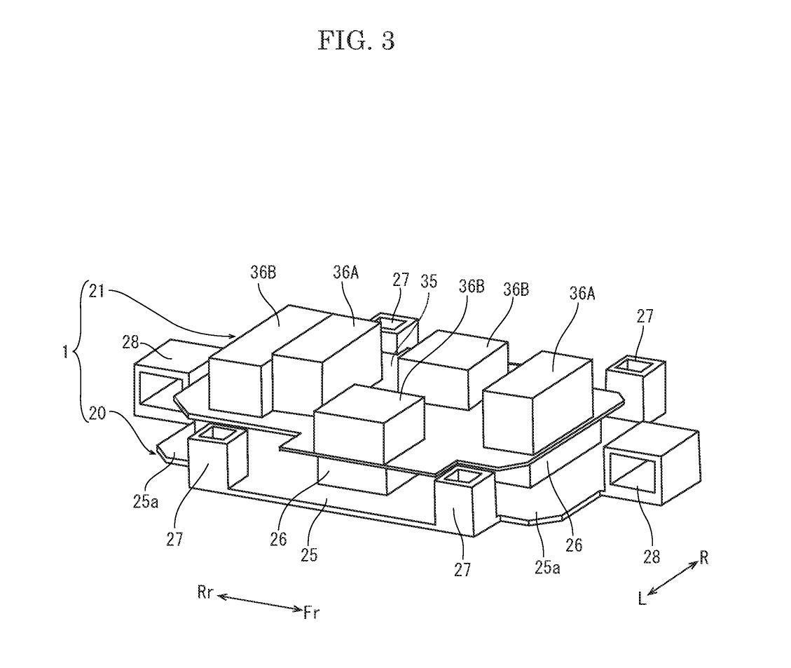

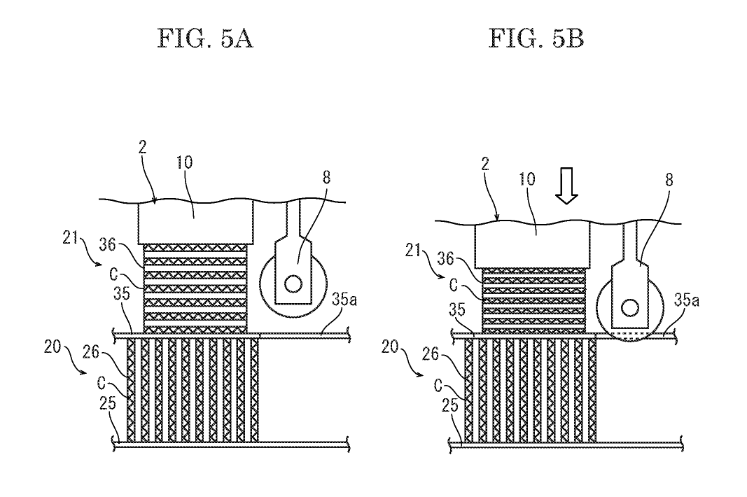

Next, a packaging structure 1 will be described refer to FIG. 1 and FIG. 3 to FIG. 5A and FIG. 5B. FIG. 3 is a perspective view showing the packaging structure, FIG. 5A is a side view showing the packaging structure at packaging and FIG. 5B is a side view showing the packaging structure at falling. The packaging structure 1 is interposed between the lower face of the sheet feeding unit 2 and the bottom plate of the packaging box 3 in order to protect the casters 8 and the tray caster 9 of the sheet feeding unit 2. The packaging structure 1 has a height (hereinafter, call as an allowance height) that a predetermined clearance is added to the protruding length of the casters 8 and the tray caster 9. When the protruded length of the casters 8 and the tray caster 9 is 130 mm, the allowance height H is 150 mm, for example.

As shown in FIG. 3, the packaging structure 1 includes a lower buffering member 20 and an upper buffering member 21 which are stacked in the vertical direction.

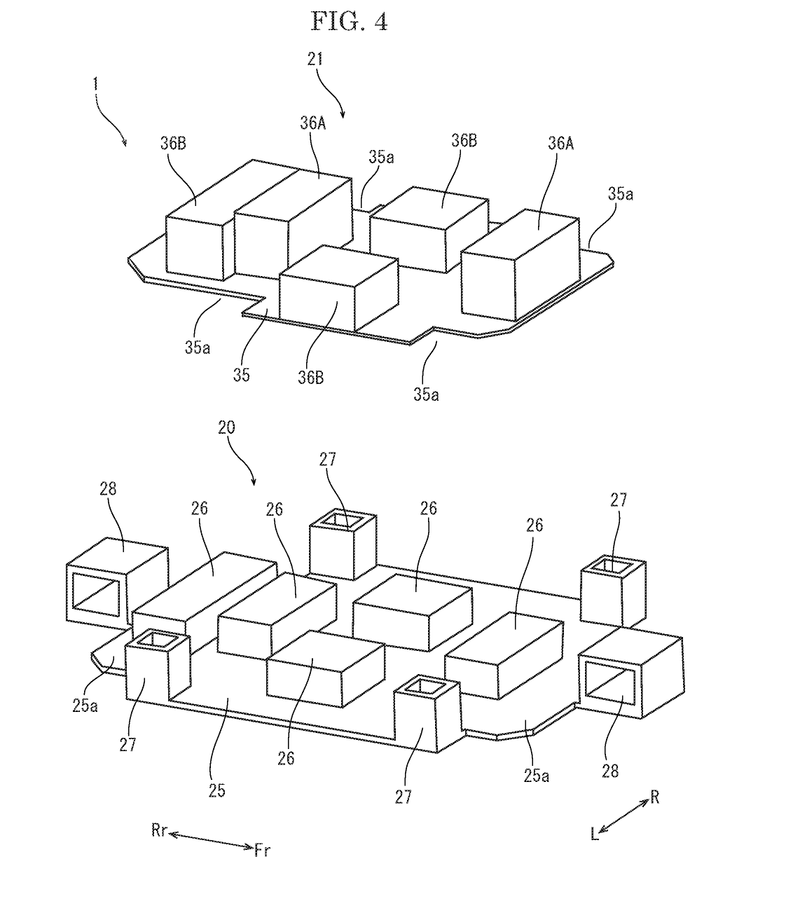

As shown in FIG. 4, the lower buffering member 20 has a lower base member 25, five lower laminated blocks 26 bonded on an upper face of the lower base member 25 and six spacers 27, 28 provided around the lower laminated blocks 26.

The lower base member 25 has an approximately same rectangular shape as a plan shape of the sheet feeding unit 2. Along front and rear edges of the lower base member 25, front and rear extended portions 25a are respectively extended. Each corner of the extended portion 25a is chamfered. The lower base member 25 is made of a corrugated cardboard.

The lower laminated block 26 is produced by laminating a plurality of corrugated cardboards C with ridge lines of corrugated cores crossing each other at right angles and then bonding them together. As shown in FIG. 5, a laminating direction of the corrugated cardboards C is along the vertical direction. In other words, the corrugated cardboards C are arranged vertically relative to the lower base member 25.

The five lower laminated blocks 26 are bonded on the upper face of the lower base member 25 at a center of a front end portion, a center of a rear end portion, the rear extended portion 25a, slightly inside of a center of a left end portion and slightly inside of a center of a right end portion. Thus, the five lower laminated blocks 26 are positioned corresponding to the lower face (shown by A in FIG. 2) of the tray 6 between the front side casters 8 of the sheet feeding unit 2, the lower face (shown by B in FIG. 2) of the tray 6 between the rear side casters 8, a center portion (shown by C in FIG. 2) of the end frame 11, a left end portion (shown by D in FIG. 2) of the center frame 10 and a right end portion (shown by E in FIG. 2) of the center frame 10. The five lower laminated blocks 26 have a same height . The height is a half of the allowance height H, for example. If the allowance height H is 150 mm, the height of the lower laminated block 26 is 75 mm.

The spacer has first spacers 27 stood up from four corners of the upper face of the lower base member 25 and second spacers 28 connected to a front edge of the front extended portion 25a and a rear edge of the rear extended portion 25a. The first spacer 27 has a square cylinder shape directed vertically. The second spacer 28 has a square cylinder shape directed horizontally. The first spacers 27 and the second spacers 28 have a height higher than the height of the lower laminated block 26. The first spacer 27 and the second spacer 28 are formed by folding a belt-shaped piece connected to the lower base member 25 into a square cylinder.

The upper buffering member 21 has an upper base member 35 and five upper laminated blocks 36 bonded on an upper face of the upper base member 35.

The upper base member 35 has a rectangular shape with a shorter length in the front and rear directions than the lower base member 25 of the lower buffering member 20. At four corners of the upper base member 35, notches 35a are formed. The notches 35a are positioned corresponding to the four casters 8 of the sheet feeding unit 2. The upper base member 35 is made of a corrugated cardboard.

The upper laminated block 36 is produced by laminating a plurality of corrugated cardboards C with ridge lines of corrugated cores crossing each other at right angles and then bonding them together, as with the lower laminated blocks 26. As shown in FIG. 5, a laminating direction of the corrugated cardboards C is along the horizontal direction. In other words, the corrugated cardboards C are arranged in parallel to the upper base member 35.

The five upper laminated blocks 36 are bonded on the upper face of the upper base member 35 at a center of a front end portion, slightly inside of a center of a rear end portion, the center of the rear end portion, slightly inside of a center of a left end portion and slightly inside of a center of a right end portion so as to correspond to the five lower laminated blocks 26 of the lower buffering member 20 in the vertical direction. The upper laminated blocks 36A bonded on the center of the front end portion and slightly inside of the center of the rear end portion each have a height higher than the other upper laminated blocks 36B. The height of the upper laminated blocks 36A is a half of the allowance height H, for example. If the allowance height H is 150 mm, the height of the upper laminated blocks 36A is 75 mm.

A method of packaging the sheet feeding unit 2 into the packaging box 3 using the packaging structure 1 having the above configuration will be described. First, the upper buffering member 21 is placed on the upper faces of the lower laminated blocks 26 of the lower buffering member 20 inside of the first, second spacers 27, 28. Then, the upper buffering member 21 is positioned relative to the lower buffering member 20 so as to overlap the upper laminated blocks 36 on the lower laminated blocks 26 along the vertical direction. Then, the upper laminated blocks 36 are stacked on the lower laminated blocks 26 through the upper base member 35.

Then, the lower buffering member 20 and the upper buffering member 21 which are positioned as described above is placed on the bottom plate of the packaging box 3. At this time, the first spacers 27 and the second spacers 28 come in contact with the side plates of the packaging box 3.

Next, when the sheet feeding unit 2 is stored in the packaging box 3, the five upper laminated blocks 36 come in contact with the lower face (shown by A in FIG. 2) of the tray 6 between the front side casters 8 of the sheet feeding unit 2, the lower face (shown by B in FIG. 2) of the tray 6 between the rear side casters 8, the center portion (shown by C in FIG. 2) of the end frame 11, the left end portion (shown by D in FIG. 2) and the right end portion (shown by E in FIG. 2) of the center frame 10. In addition, as shown in FIG. 5A, the casters 8 and the tray caster 9 are held in the floating state from the upper base member 35 of the upper buffering member 21.

Then, buffering members (not shown) are interposed between side faces and upper face of the sheet feeding unit 2 and the side plates and the lid flaps of the packaging box 3 and then the packaging box 3 is sealed.

If the packaging box 3 in which the sheet feeding unit 2 is packaged as described above is fallen vertically, as shown in FIG. 5B, the upper laminated blocks 36 of the upper buffering member 21 on which the sheet feeding unit 2 is directly placed are compressed so that an impact caused by the falling can be absorbed. At this time, the casters 8 protrude downward through the notches 35a of the upper base member 35. The tray caster 9 also protrudes downward from the upper base member 35. Thus, the casters 8 and the tray caster 9 can be protected so as not to abut against the bottom plate of the packaging box 3 when the packaging box 3 is fallen.

Since the laminating direction of the upper laminated block 36 is along the horizontal direction, the corrugated core is crushed in the vertical direction so that the upper laminated blocks 36 is compressed. On the other hand, since the laminating direction of the lower laminated block 26 is along the horizontal direction, the lower laminated block 26 has high pressure resistance strength in the vertical direction and is hardly compressed and deformed. Accordingly, the impact applied to the sheet feeding unit 2 at the falling can be absorbed without applying damage and large deformation on the entire of the packaging structure 1.

Furthermore, when the packaging box 3 is fallen with the ridge line downward, the upper laminated blocks 36 are compressed so that an impact can be absorbed.

As described above, according to the packaging structure 1 of the present disclosure, since the upper laminated blocks 36 and the lower laminated blocks 26 each have a low height, it makes possible to prevent the deteriorating of the production yield of the laminated block. In addition, owing to the low height of the laminated block, the laminated block may be hardly deformed by displacement and inclination at the bonded face between the corrugated cardboards. For example, in a case where the sheet feeding unit 2 having casters on its lower face is packaged as a packaged article, a distance between the lower face of the packaged article and the bottom plate of the packaging box 3 becomes long (for example, the allowance height is 150 mm). If one laminated block may be interposed between the lower face of such sheet feeding unit 2 and the bottom plate of the packaging box 3, it is necessary to increase a number of corrugated cardboards to be laminated. Accordingly, the production yield of the laminated block deteriorates and the deformation, such as displacement and inclination at the bonded face between the corrugated cardboards, easily occurs when the packaging box 3 is fallen with the ridge line downward. However, in the present disclosure, if the distance between the lower face of the packaged article and the bottom plate of the packaging box is long, one laminated block can have a height of about 75 mm. Accordingly, the deterioration of the production yield of the laminated block can be prevented and the deformation hardly occur even if the packaging box 3 is fallen with the ridge line downward.

Furthermore, the lower laminated block 26 which is produced by laminating the corrugated cardboards in the horizontal direction and bonding them together provides the packaging structure 1 with pressure resistance strength in the vertical direction. On the other hand, since the upper laminated block 36 is produced by laminating the corrugated cardboards in the vertical direction and bonding them together, although the pressure resistance strength in the vertical direction is smaller than that of the lower laminated block 26, buffering property in the vertical direction can be provided. Thus, since the upper laminated block 36 and the lower laminated block 26 have different pressure resistance strength in the vertical direction, the packaging structure 1 can keep the pressure resistance strength while absorbing the applied impact at the falling.

In the embodiment, the pressure resistance strength of the upper laminated block 36 and the lower laminated block 26 is made different from each other by varying the laminating direction of the corrugated cardboards. However, by varying a thickness of the corrugated cardboard C (a thickness of a liner or a corrugated core), the pressure resistance strength may be made different.

Furthermore, the pressure resistance strength of the upper laminated block 36 and the lower laminated block 26 can be adjusted depending on a weight or characteristic of the packaged article. Alternatively, the upper laminated block 36 and the lower laminated block 26 may have the same pressure resistance strength. In addition, a number of the laminated blocks stacked in the vertical direction is not limited to two. If the distance between the lower face of the packaged article and the bottom plate of the packaging box is long, two or more laminated blocks may be interposed.

Further, in the embodiment, the upper laminated blocks 36 and the lower laminated blocks 26 are bonded on the upper base member 35 and lower base member 25 respectively. Accordingly, when it is necessary to stack a plurality of upper and lower laminated blocks in the vertical direction within the same plane, for example, when the lower face of the packaged article has a large area or when a plurality of packaging structure 1 are separately arranged, it becomes easy to position the upper laminated block 36 and the lower laminated block 26 in the vertical direction.

However, the upper and lower base member 35, 25 are not necessary. If the upper and lower base member 35, 25 are not provide, the upper laminated block 36 is directly placed on the lower laminated block 26. Here, an area of the upper face of the lower laminated block 26 makes to be larger than an area of the lower face of the upper laminated block 36. Then, if the upper laminated block 36 slides on the lower laminated block 26 in the oblique direction when the packaging box 3 is fallen with the ridge line downward, the upper laminated block 36 can be prevented from being displaced from the lower laminated block 26.

While the preferable embodiment and its modified example of the packaging structure of the present disclosure have been described above and various technically preferable configurations have been illustrated, a technical range of the disclosure is not to be restricted by the description and illustration of the embodiment. Further, the components in the embodiment of the disclosure may be suitably replaced with other components, or variously combined with the other components. The claims are not restricted by the description of the embodiment of the disclosure as mentioned above.

1. A packaging structure comprising a plurality of laminated blocks produced by laminating a plurality of corrugated cardboards and then bonding them together,
wherein the laminated blocks are stacked in a vertical direction and interposed between a lower face of a packaged article and a bottom face of a packaging box.

2. The packaging structure according to claim 1,
wherein the laminated block is produced by laminating the plurality of corrugated cardboards with ridge lines of corrugated cores of the corrugated cardboards crossing each other at right angles and then bonding them together.

3. The packaging structure according to claim 1,
wherein the laminated blocks stacked in the vertical direction each have different pressure resistance strength.

4. The packaging structure according to claim 3,
wherein the pressure resistance strength of the upper laminated block is smaller than the pressure resistance strength of the lower laminated block.

5. The packaging structure according to claim 1,
wherein an area of an upper face of the lower laminated block is larger than an area of a lower face of the upper laminated block.

6. The packaging structure according to claim 1,
wherein a height of the laminated block is 75 mm or smaller.

7. The packaging structure according to claim 1, comprising a base member on which the laminated blocks are supported.

8. The packaging structure according to claim 1, comprising a spacer interposed between a side face of the packaged article and a side face of the packaging box.

9. The packaging structure according to claim 1,
wherein the laminated blocks each include a lower laminated block and an upper laminated block which are stacked in the vertical direction,
a laminating direction of the corrugated cardboards of the lower laminated block is along a horizontal direction and
a laminating direction of the corrugated cardboards of the upper laminated block is along the vertical direction.

10. The packaging structure according to claim 1,
wherein the packaged article is a sheet feeding unit having a plurality of casters on a lower face of the sheet feeding unit, and
the plurality of laminated blocks are interposed between the lower face of the sheet feeding unit and the bottom face of the packaging box in a space between the adjacent casters.
